(19) United States
(12) Patent Application Publication
(10) Pub. No.: US 2002/0050673 A1
(43) Pub. Date: May 2, 2002

(54) Vise jaw plates and cooperating work piece holders

(76) Inventor: Truman Collins, Pacific, WA (US)

Correspondence Address: David L. Tingey, Suite 303, 321 Burnett Ave. S., Renton, WA, 98055, US

(21) Appl. No.: 09/950,191

(22) Filed: Sep. 10, 2001

Related U.S. Application Data
(63) Continuation of application No. 08/245,640, filed on May 18, 1994, now abandoned.
Application No. 08/245,640 is a continuation of application No. 08/674,800, filed on Jul. 3, 1996, now abandoned.

(51) Int. Cl. B25B 1/24

(52) U.S. Cl. 269/282

(57) ABSTRACT

Vise jaw plates and matching work piece holders cooperate to reliably secure an odd-shaped object in a preferred orientation between the plates. At least one of a plurality of work piece holders are disposed throughout the jaw in an orthogonal pattern with the plate holes precisely aligned in rows and columns and spaced apart a same distance such that a selected work piece holder with one or more mount posts matching the jaw holes is mountable equally well throughout the plate.

This application is a continuation of this inventor's prior application filed in the United States Patent and Trademark Office on Feb. 8, 1999 and assigned Ser. No. 08/245,640, which was a continuation of this inventor's prior application filed Jul. 3, 1996 and assigned Ser. No. 08/674,800.

### BACKGROUND

1. Field of the Invention

This invention relates to vises and particularly to vise jaws and accessories thereto, specifically jaw plates and work piece holders used in combination with the plates.

2. Prior Art

It is known in the art to have general purpose vises with vise jaws appurtenant thereto with opposing flat surfaces for generally securing flat objects therebetween. Such vises are routinely used with mills, grinders, lathes, and machining centers.

Machining often requires accuracy to within 0.001″ or less, requiring the vise to secure an object reliably to an accuracy of less than that tolerance. However, it is often difficulty to reliably secure an object that does not have at least one flat surface that can be secured against a vise while the object is oriented as necessary for the machine work. Heretofore, the capability to support a work piece in a preferred orientation in a vise remained unavailable, especially for irregularly-shaped objects.

### SUMMARY

The primary object of the present invention is to provide a versatile vise jaw reconfigurable to secure a variety of shapes and sizes of work pieces in an advantageous orientation.

This object is achieved in a pair of opposing jaw plates each with front and back flat sides typical of vise jaws, the improvement in each comprising a precise uniform orthogonal pattern of holes in their front (opposing) sides. The holes are dual-purpose in receiving an unthreaded dowel or a threaded shoulder bolt, including a first unthreaded portion suitable for securely receiving a dowel closely therein. For securing the dowel in the unthreaded portion without wobble, the hole depth is twice its diameter. The hole terminates in a threaded portion immediately following the unthreaded portion and having a diameter less than that of the unthreaded portion diameter allowing bolt threads to pass through the unthreaded portion and engage the threads of the hole threaded portion. Thus, a bolt, such as a shoulder bolt, can be threaded into the hole threaded portion therein providing a positive attachment of the work piece holder to the plate. Typically, the unthreaded portion is sized to closely receive standard 1/4-inch dowel pins to a hole depth of ⅝-inch.

Another object is to provide that work piece holders with at least two dowels or bolts employed to secure the holder to a plate may be positioned on the plate at any advantageous position. This object is achieved in centers of the at two dowels or bolts being spaced apart a set distance, d, and with respective plate holes spaced apart from centers of vertical and horizontal neighboring plate holes said distance, d.

A further object is to provide a number of versatile jaw work piece holders as accessories to the versatile vise jaw plates, each with at least one dowel pin or shoulder bolt for insertion in the plate holes. Typically, two or more work piece holders advantageously selected from a collection of work piece holders are employed in concert with each other and in combination with the jaw plates to secure a work piece between the vise jaws. The work piece holders can be employed on one or both plates as may be dictated by the shape of the work piece.

Work piece holders include a plurality of dowels extendable in the holes beyond the jaw front side. Thus, for example, dowels placed in a first line of holes in the jaw together with dowels placed in a second line of holes orthogonal to the first line present a rectangular support for an object to be supported at 45-degrees in the jaw. Similarly, a dowel placed in the jaw may cooperate with another dowel or another different work piece holder, such as a sine bar, for example, elsewhere in the jaw to define a line for supporting an object at an angle. Likewise, two or more pins may serve to support curvilinear surfaces, such as a round, between the pins.

For other unusual shapes, such as an object with acute-angled surfaces to be secured, an different selective member from the collection of work piece holders can be employed, such as a pivot bar which comprises an elongated member with a flat longitudinal side with a dowel in its back side for engaging the jaw. The pivot bar then pivots on the dowel to match the angle of the object being secured in the vise. A pair of pivot bars or a pivot bar in concert with another work piece holder, such as a dowel, may be advantageously employed together to secure the object.

A sine bar is also provided in an elongated member having a hole on a pivot end through which a shoulder bolt passes into a jaw hole and on which the bar pivots. It can be tightened into a positive secured position on the plate by threading the shoulder bolt tightly into the jaw hole threads. Typically, the hole includes a concentric countersunk hole for receiving the bolt head within the work piece. The other end, or free end, of the elongated member is supported at a bar support pin by one from a set of blocks of calculated height intended to rest on the vise or by a selected work piece, such as an angle block or a cam block, described below. The support block or other work piece holder is then chosen that supports the free end at the desired height equal to the bar length.

A “V” block is useful for holding curvilinear objects vertically or horizontally, depending on its orientation. With a hole centered on the “V” and another on each side spaced apart to match those of the vise jaw, a dowel between the “V” block and jaw mounts the “V” block to the jaw. A single dowel mounted in the center hole allows the block to pivot to accommodate nonstandard shapes at any desired angle. A dowel in each of the outside block holes allows a vertical or horizontal orientation.

Yet another work piece holder is a spring-loaded parallel keeper, designed to hold parallels in place during machining operations, mounted to the versatile jaw with bolts passing through a mounting hole in a keeper mounting bar and entering jaw threaded holes from the jaw back.

### BRIEF DESCRIPTION OF THE DRAWINGS

FIG. 1 is a perspective view of a vise with vise jaw plates of the present invention.

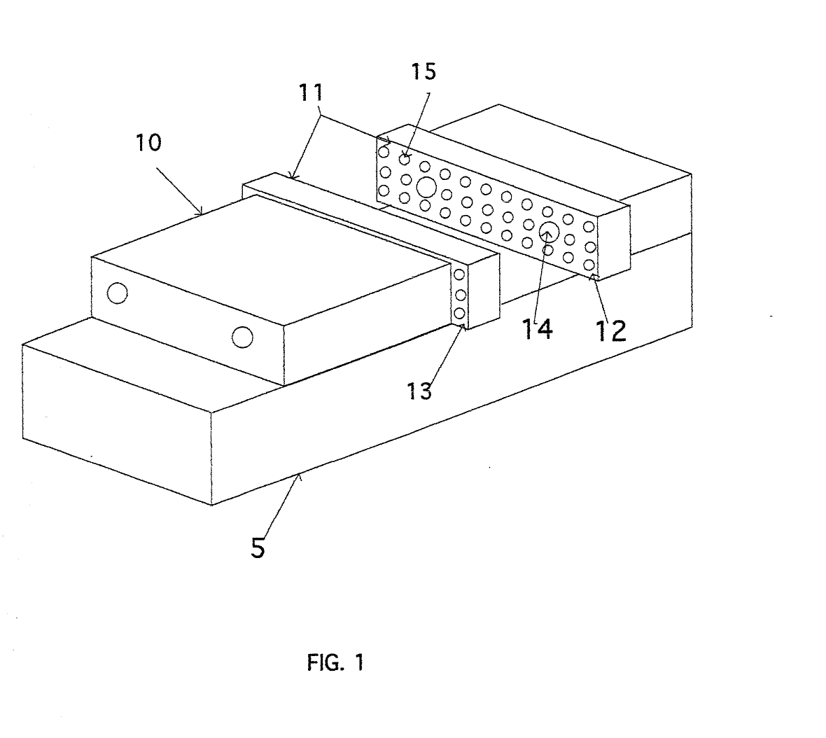

FIG. 2 is front and side views of the vise jaw plates.

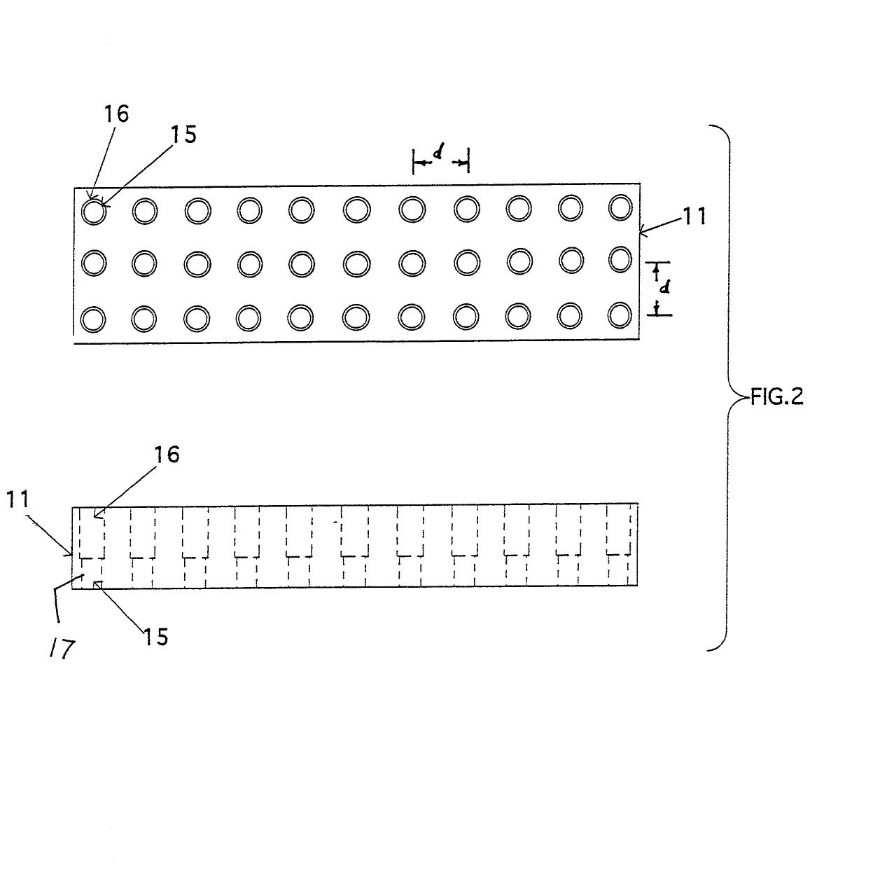

FIG. 3 shows a plurality of dowels sized to fit in holes of the versatile vise jaw.

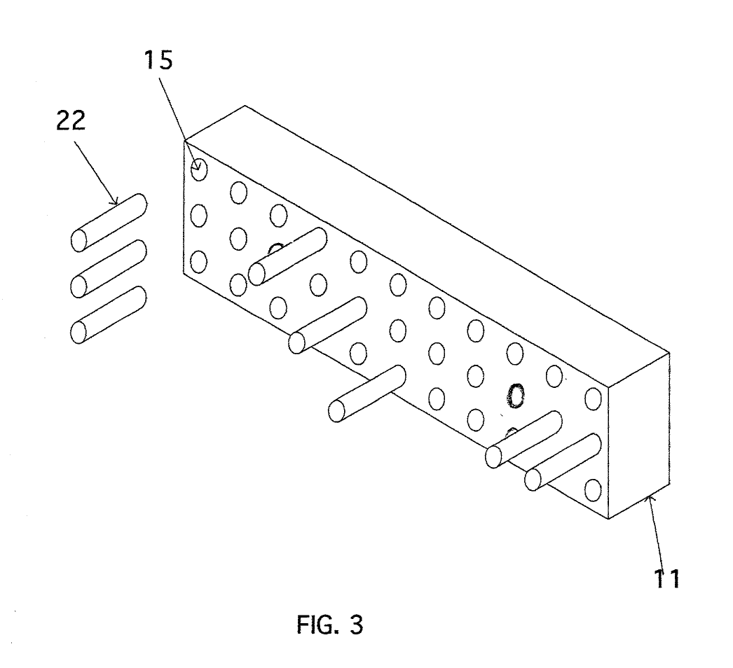

FIG. 4 is side and end views of a V-block.

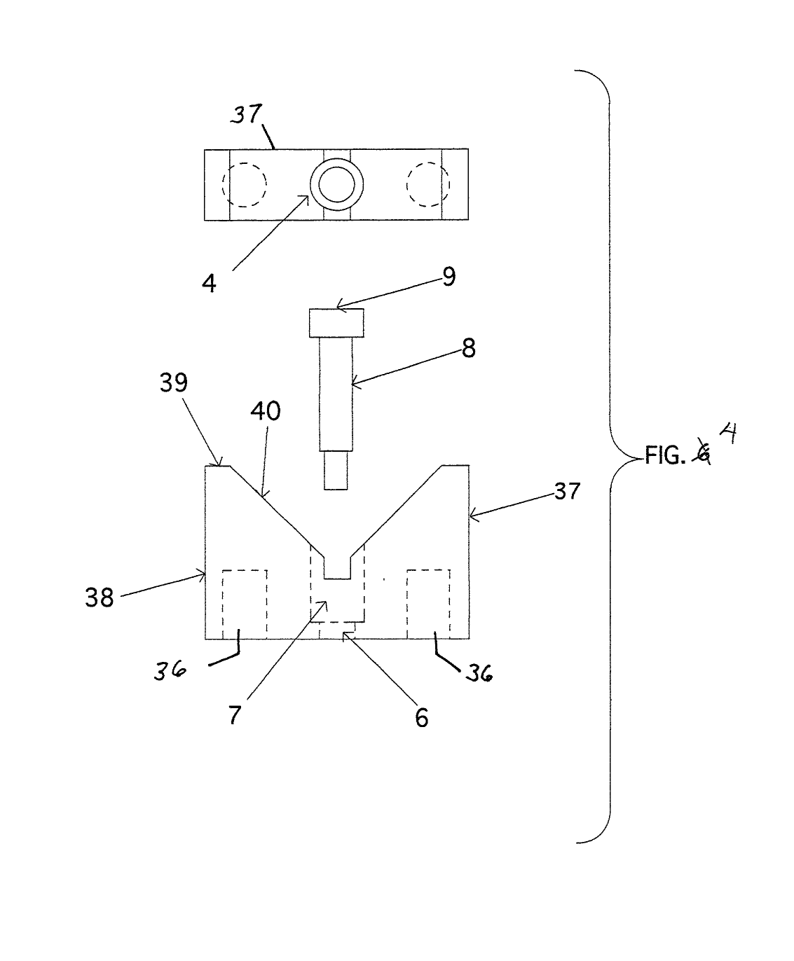

FIG. 5 is top, side, and end views of an arc block.

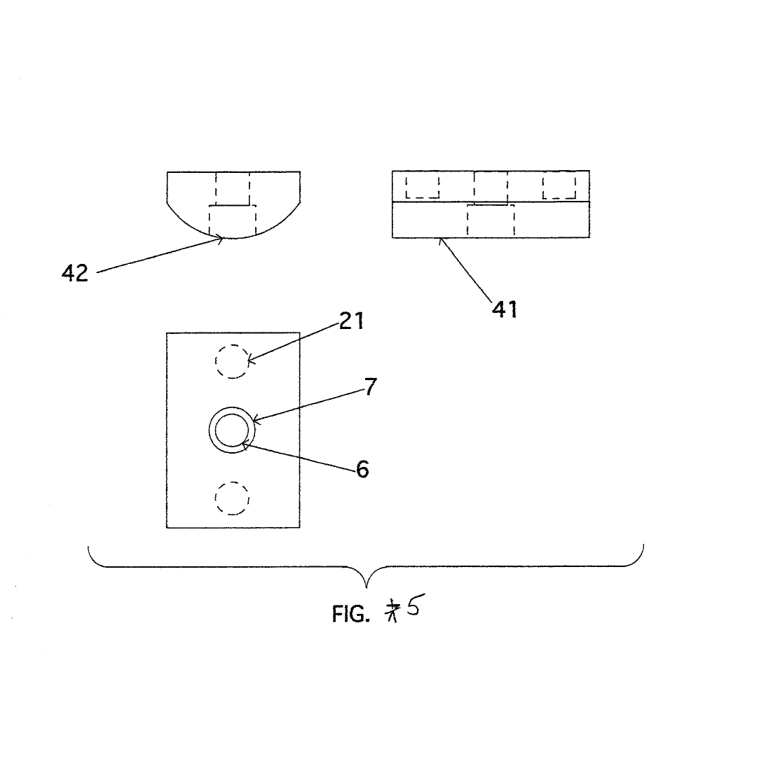

FIG. 6 is front and top views of an arc block. The top view shows the arc block securing an odd-shaped part between the pair of plates in cooperation with a dowel.

FIG. 7 is an end view of arc blocks mounted on a plate and a V-block mounted on an opposing plate shown cooperating to support a round part.

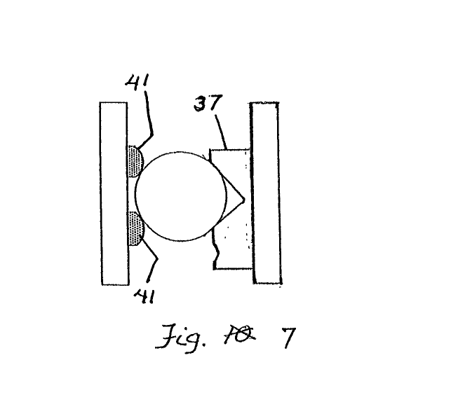

FIG. 8 is a perspective view of the clamp used in concert with the vise plates to secure a work piece in a vise.

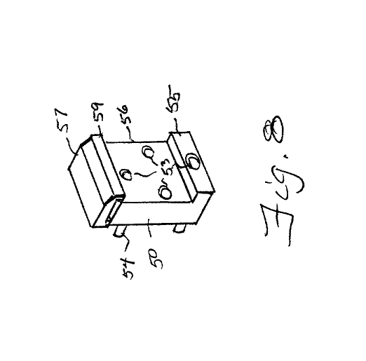

FIG. 9 is front, side and top views of the clamp of FIG. 8.

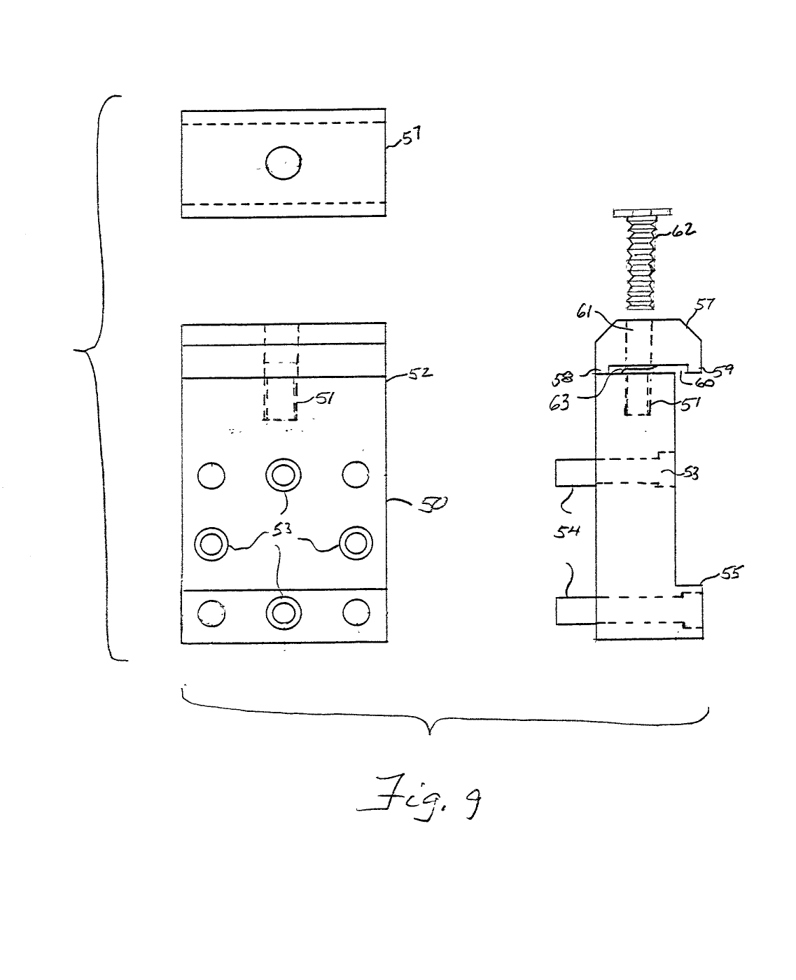

### DETAILED DESCRIPTION OF THE PREFERRED EMBODIMENT

Referring to the drawings, the present invention comprises a versatile vise jaw 10 for use with a vise 5 and at least one work piece holder and typically two or more holders selected from a collection of work piece holders for use therewith as my be required in securing an object of arbitrary shape between vise plates.

The vise jaw comprises first and second opposing jaw plates 11 each with parallel, flat front and back sides 12 and 13. Each plate comprises a plurality of same-sized plate holes 15 aligned vertically and horizontally in an orthogonal pattern with centers of holes 15 spaced apart from neighboring hole centers a same distance, d. Each hole 15 has an unthreaded portion 16 for receiving a dowel with its depth greater than its diameter, typically at least double its diameter, for securing the dowel in the hole unthreaded portion. Each hole 15 further has a threaded portion 17 immediately following the unthreaded portion having diameter less than that of the unthreaded portion and suitable for receiving a bolt from a work piece holder.

The jaw plates may also have one or more vise mounting holes 14 for mounting the plates to typical vise jaws, superimposed over the array of same-sized plate holes.

At least one work piece holder, and typically two or more holders, are employed in concert with each other and the plates to secure a work piece between the plates. The work piece holder may employ at least one of a threaded bolt matching the plate hole threaded portion or a cylindrical post 18 matching the plate hole unthreaded portion. When employing at least two of either a threaded bolt or a cylindrical post, they are spaced apart a same distance, d, to match positions of the plate holes for positioning the work piece holder at any preferred position on the plates.

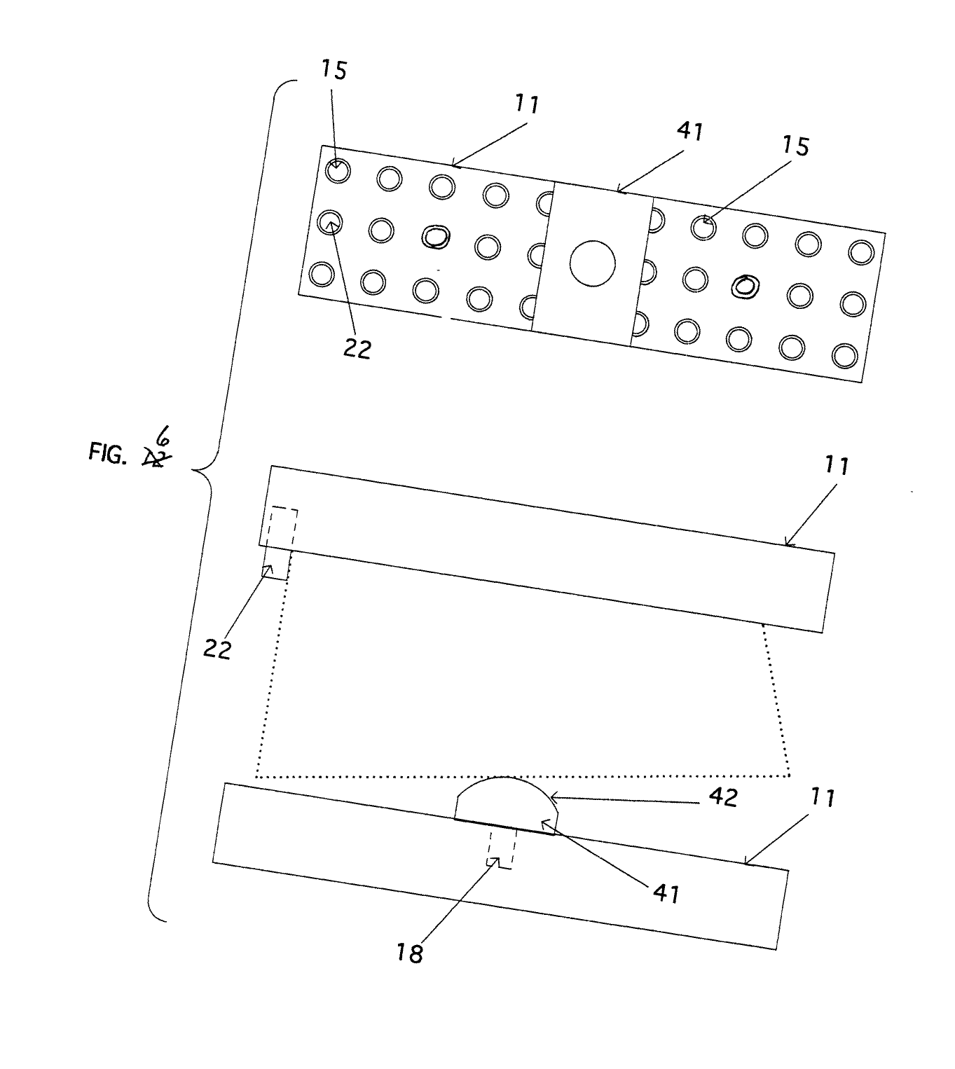

A first work piece holder used in concert with the plates comprises one or more dowels 22 sized to fit closely in plate hole 15 of appropriate length sufficient to extend from the plate hole unthreaded portion to support a work piece on the plate. FIG. 6 shows the dowel employed in concert with an arc block (described below), both mounted on the plates to secure a work piece between the plates.

A second work piece holder used in concert with the plates is a V-block 37 comprising a parallelepipedonal base 38 with a top 39 having a triangular transverse cross-sectional recess 40 and a bolt hole 6 through its top 39 with a concentric countersunk hole 7 through which a bolt 8 may pass. With a hole 6 centered on the “V” and another hole 36 on each side each spaced apart from the center hole said same distance, d, a dowel in the side holes 36 mounts the V-block to the jaw in either a vertical or horizontal orientation, or alternatively, a single dowel mounted in the center hole 6 allows the block to pivot to accommodate nonstandard shapes at any desired angle. As a further alternative for obtaining a positive attachment of the V-block to one of the plates, a bolt 8 is threaded into the plate hole threaded portion with a bolt head 9 enclosed in the countersunk hole 7.

A third work piece holder used in concert with the plates is an arc block 41 having a continuous curvilinear top 42, such as a semicircle. When the arc block is mounted on a plate spaced apart from other work piece holders, the top is directed toward the opposing plate. To secure the arc block 41 to the vise jaw plates 11, a post 18 sized to match the plate holes is directed away from the top.

A fourth work piece holder used in concert with the plates includes a body 50 with a threaded body hole 51 in its top 52. Mounting bolt holes 53 extend through the body spaced apart a multiple of the common distance, d, so that a bolt can pass through the holes and into the vise plate to mount the work piece holder to the vise plates. A pair of posts 54 spaced apart a multiple of the common distance, d, extend in parallel from the body 50 and removably engages one of the plates 11 in two plate holes 14. A support 55 extends from the body 50 from a side 56 opposite the posts 54. A cap 57 with a post-side leg 58 and a support-side leg 59 defines a cap recessed channel 60 therebetween with a cap bolt hole 61 opening into the channel 60. The cap 57 is bolted to the body top 52 with a bolt 62 passing loosely through the cap bolt hole 61 and engaging the threaded body hole 51 with the post-side leg 58 supporting the cap 57 on the body 50 and the support-side leg 59 extending over the body 50 opposite the support 55. A compressed spring 63 within the channel 60 biases the cap 57 away from the body 50 with the cap 57 pivotable on the post-side leg 58 such that the support-side leg 59 adjusts to grasp a work piece between it and the support as the bolt is tightened into the body threaded hole.

One skilled in the art will recognize the advantages taught by this invention and illustrated by the preferred embodiment presented. The specification and drawings are not intended to represent an exhaustive description of the invention. Clearly, for example, additional and different support accessories may be combined for use with the versatile vise jaw. These and other obvious applications and extensions of the invention are intended to be within the spirit and scope of this invention.

Having described the invention, what is claimed is as follows:

1. A versatile vise jaw mountable to a vise, the improvement comprising
a pair of opposing jaw plates, at least one of said jaw plates having a plurality of plate holes, all plate holes having a same size and disposed in an orthogonal pattern, the plate holes being aligned in rows and columns with each hole center respectively spaced apart a same distance, d, from its nearest holes both in its respective row and in its respective column such that a work piece holder with at least two posts each matching a plate hole and with post centers spaced apart a same distance, d, fits equally well in plate holes at any position throughout the hole pattern, in which each plate hole is adapted to receive both an unthreaded post and a threaded bolt, including an unthreaded portion sized to receive said work piece holder mounting post, the mounting hole immediately beyond the recess threaded to receive a threaded bolt, the hole unthreaded portion being of depth suitably greater than its diameter for securing a post in the hole unthreaded portion, and
means for mounting said jaw plates to a vise superimposed over the pattern of same-sized plate holes.

2. A versatile vise jaw mountable to a vise, the improvement comprising
a pair of opposing jaw plates, at least one of said jaw plates having a plurality of plate holes, all plate holes having a same size and disposed in an orthogonal pattern, the plate holes being aligned in rows and columns with each hole center respectively spaced apart a same distance, d, from its nearest holes both in its respective row and in its respective column adapted to receive two posts of a work piece holder in two of said nearest holes, each post matching a plate hole with post centers spaced apart said same distance, d, and,
means for mounting said jaw plates to a vise superimposed over the pattern of same-sized plate holes.

3. The vise jaw of claim 2 and further comprising
a first work piece holder comprising a single curvilinear top forming an arc directed longitudinally outward toward the opposite plate including a post received into at least one of the plate same-sized holes opposite the top,
a second work piece holder comprising a dowel received into the plate hole unthreaded portion and of length sufficient to extend from the hole,
each work piece holder spaced apart from any other work piece holder, the work piece holders cooperating to support a work piece therebetween and between the plates.

4. The vise jaw of claim 2 and further comprising
a first work piece holder comprising a top having a triangular transverse cross-sectional recess,
a second work piece holder comprising a dowel received into the plate hole unthreaded portion and of length sufficient to extend from the hole,
each work piece holder spaced apart from any other work piece holder, the work piece holders cooperating to support a work piece therebetween and between the plates.

5. The vise jaw of claim 2 further comprising
first and second work piece holders each with two cylindrical posts removably mounted into two of said nearest plate holes, said work piece holders spaced apart in cooperative relation on the vise plate to receive a work piece therebetween, said posts sized to match said plate holes.

6. The vise jaw of claim 2 further comprising
a body with a threaded body hole in its top and a body recess around the hole,
a pair of posts spaced apart said distance, d, extending in parallel from said body and removably engaging one of said plates in two plate holes,
a support extending from the body from a side opposite the posts,
a spring,
a cap with a post-side leg and a support-side leg defining a cap recessed channel therebetween with a cap bolt hole opening into the channel, the cap bolted to the body top with a bolt passing loosely through the cap bolt hole and engaging the threaded body hole with the post-side leg supporting the cap on the body and the support-side leg extending over the body opposite the support, the compressed spring within the channel biasing the cap away from the body, the cap pivotable on the post-side leg such that the support-side leg adjusts to grasp a work piece between it and the support as the bolt is tightened into the body threaded hole.

7. The method of securing an irregularly-shaped work piece in a selective position in a vise, comprising the steps of
a. Securing a pair of vise plates to the vise, the plates having a plurality of plate holes, all plate holes having a same size and disposed in an orthogonal pattern, the plate holes being aligned in rows and columns with each hole center respectively spaced apart a same distance, d, from its nearest holes both in its respective row and in its respective column and means for mounting said jaw plates to a vise
b. mounting a first work piece holder on at least one of the plates in a selective one of said holes of said plates,
c. mounting a second work piece holder spaced apart from the first work piece holder on the same plate in a different one of said holes of said plates, the first and second work piece holders cooperating to support a work piece therebetween and between the plates.

8. The method of claim 7 wherein third step includes the step of mounting a second work piece holder of configuration different than the first work piece holder on the same plate.

9. The method of claim 7 wherein the second step includes the step of mounting a dowel received into the plate hole of length sufficient to extend from the hole.

10. The method of claim 7 wherein the second step includes the step of mounting a first work piece holder having a single curvilinear top forming an arc directed longitudinally outward toward the opposite plate including a post received into at least one of the plate same-sized holes opposite the top.

11. The method of claim 7 wherein the second step includes the step of mounting a first work piece holder having a top with a triangular transverse cross-sectional recess.
